(19) United States
(12) Patent Application Publication
(10) Pub. No.: US 2008/0306784 A1
(43) Pub. Date: Dec. 11, 2008

(54) Computer-implemented methods and systems for analyzing clauses of contracts and other business documents

(76) Inventors: Vijay Rajkumar, Redwood City, CA (US); Rhonda Stieber, Los Altos, CA (US); Yoay Eilat, Mountain View, CA (US); Marat Uteshev, Mountain View, CA (US); Rajesh Vohra, Santa Clara, CA (US); Manash Sengupta, Redwood Shores, CA (US); Chetan Yelamanchi, San Francisco, CA (US); Anjani Kumar, Sunnyvale, CA (US)

Correspondence Address: YOUNG LAW FIRM, P.C., 4370 ALPINE RD., STE. 106, PORTOLA VALLEY, CA, 94028, US

(21) Appl. No.: 11/758,522

(22) Filed: Jun. 5, 2007

(51) Int. Cl. G06F 9/44

(52) U.S. Cl. 705/7

(57) ABSTRACT

A computer-implemented method for analyzing clauses of business documents of an enterprise may include steps of providing a database and storing a plurality of business documents used by the enterprise in the database. Each of the plurality of business document stored in the database may include a plurality of clauses, and each of the plurality of clauses may be associated with a plurality of clause attributes and a clause attribute value for each of the plurality of clause attributes. The method may include steps of prompting for a value of at least one of the clause attributes; obtaining at least one value for the prompted clause attributes and querying the database to identify all occurrences of clauses used in at least one of the stored business documents whose clause attribute values match each obtained value for the prompted clause attributes. A business document clause analysis report may then be generated that includes each identified matching clause occurrence.

### BACKGROUND OF THE INVENTION

1. Field of the Invention

Embodiments of the present invention relate to computer-implemented methods and systems for analyzing clauses of contracts and other business documents.

2. Description of the Prior Art and Related Information

Companies conventionally have many business documents that they use to define business relationships with their customers, vendors and partners. Most large companies have business practice organizations that author standard clauses and templates for standard business documents (such as, for example, contracts, licenses, purchase orders, quotes, lease agreements and the like) that are approved for use in various types of contracts. When companies negotiate contracts or author other types of business documents, they try to use the standard language whenever possible, both to promote uniformity in their business relations and to reduce legal liability by using only approved and vetted language. Because some deals or other corporate undertakings do not lend themselves to standard boilerplate language, the need remains for authoring custom, non-standard clauses for use in business documents. Often this is done as a result of negotiations carried out by a representative of the company as he or she drives the deal forward. Non-standard clauses, however, must be carefully reviewed by business and legal personnel to ensure that they are correct and appropriate for the situation, primarily to evaluate risk and potential revenue recognition implications.

Both standard and non-standard business documents are often stored as electronic documents on a file server, and sometimes as hard copies in filing cabinets. It is, however, difficult for companies to fully understand the overall impact of such non-standard contract language in these contracts, both for individual business documents and in the aggregate across all business documents. It is also difficult for companies to analyze how often standard clauses are being modified, and which standard clauses are being most often modified or to analyze the frequency with which new custom clauses are being drafted and included in business documents. Indeed, there exists no comprehensive mechanism for analyzing the language of such business documents to identify and assess risk and to improve the company's library of standard clauses. In addition, if a company finds an issue with the language in a particular standard clause of a business document, it is very difficult to determine which other business documents may have used that problematic clause and are, therefore, potentially impacted. Moreover, there exists no mechanism to enable companies to evaluate risk exposure across their contract base (e.g., the ability to identify all contracts having non-standard liability clauses, intellectual property clauses, or contracts using a particular standard clause whose language has some issues). In addition, companies would benefit from the ability to determine which standard clauses may need to be changed in the standards library (to be consistent with current market expectations), as such standard clauses may be updated frequently during the contracting process (hence resulting in longer lead times to finalize contracts). Also, new types of clauses may need to be included in the standard templates, as new clauses are often drafted ad hoc during the contracting process.

For example, an exemplary fictional professional services company, Proserve Corp. (hereinafter “Proserve”), may have a standard clause that it uses in all its customer contracts (a type of business document) regarding terminations. Such a standard termination clause may read “Terminations: Either party may terminate this agreement at any time by providing written notice 60 days in advance.” In certain deals, Proserve's customers may negotiate different termination terms, such as a 30 day notice provision, for example. In these cases, Proserve's standard termination clause would be modified and would be thereafter considered a non-standard clause in that business document. Non-standard clauses such as this non-standard termination clause represent increased risk to Proserve. To mitigate risks in its other outstanding contracts, Proserve may want to analyze all contracts and determine which have one or more non-standard clauses and, in particular, non-standard termination clauses. For most large companies having a great many outstanding contracts, such an analysis would be very difficult and time consuming to accomplish, as it conventionally would be carried out by visually (i.e., looking at) and inspecting each outstanding contract individually. There is a need, therefore, for better tools to identify and analyze standard and non-standard clauses in business documents.

### SUMMARY OF THE INVENTION

According to an embodiment thereof, the present invention is a computer-implemented method for analyzing clauses of business documents of an enterprise. The computer-implemented method may include steps of providing a database; storing a plurality of business documents used by the enterprise in the database, each of the plurality of business document stored in the database including a plurality of clauses, each of the plurality of clauses being associated with a plurality of clause attributes and a clause attribute value for each of the plurality of clause attributes; prompting for a value of at least one of the clause attributes; obtaining at least one value for the prompted clause attributes; querying the database to identify all occurrences of clauses used in at least one of the stored business documents whose clause attribute values match each obtained value for the prompted clause attributes, and generating a business document clause analysis report that includes each identified matching occurrence.

Each of the plurality of business documents may be further associated with a plurality of business document attributes and a business document attribute value for each of the plurality of business document attributes. The computer implemented method may further include steps of prompting for a value of at least one of the business document attributes; obtaining at least one value for the prompted business document attributes, and querying the database to identify all occurrences of clauses used in at least one of the stored business documents whose business document attribute values match each obtained value for the prompted business document attribute. The report generating step may be carried out such that the business document clause analysis report is configured to include each identified matching clause occurrences. The plurality of clause attributes may include a “Summarize By” clause attribute and the method may further include a step of prompting and obtaining a value for the Summarize By clause attribute. The generated business document clause analysis report may be summarized according to the obtained value of the Summarize By clause attribute. The Summarize By clause attribute may include selectable values of Clause, Clause Version, Clause Type and None, for example. One of the plurality of business document attributes may be or include a unique business document identifier and the report generating providing step may be carried out with the business document clause analysis report providing, for each identified clause, the unique business document identifier where the identified clause is found. A step may be carried out of selecting additional clauses to add to the business document clause analysis report and the report generating step may be carried out with the business document clause analysis report including the selected additional clauses. The report generating step may be carried out with the business document clause analysis report including all versions of one or more of the identified clauses. The querying to identify step may be carried out such that each of the obtained values for the business document and clause attributes must match a corresponding one of the values for the associated business document attributes and the clause attributes. The report generating step may be carried out with the business document clause analysis report including a master table that includes a summary of the identified clauses and a selectively configurable details table that lists selected clauses from the summary. Some of the clauses of the stored business documents may be non-standard clauses and the report generating step may be carried out with the business document clause analysis report identifying those of the identified clauses that are non-standard. The clause attributes may include one or more of the following: Intent, Clause Usage, Clause keyword, Clause Type, Summarize By, Clause title, Clause Number and Organization, to name but a few possibilities. The business document attributes may include, for example, Buyer, Seller, Status, Supplier and/or Contract Template, for example.

According to another embodiment thereof, the present invention is a machine-readable medium having data stored thereon representing sequences of instructions which, when executed by a computing device, causes the computing device to analyze clauses of business documents of an enterprise, by performing the steps of providing a database; storing a plurality of business documents used by the enterprise in the database, each of the plurality of business document stored in the database including a plurality of clauses, each of the plurality of clauses being associated with a plurality of clause attributes and a clause attribute value for each of the plurality of clause attributes; prompting for a value of at least one of the clause attributes; obtaining at least one value for the prompted clause attributes; querying the database to identify all occurrences of clauses used in at least one of the stored business documents whose clause attribute values match each obtained value for the prompted clause attributes, and generating a business document clause analysis report that includes each identified matching clause occurrence.

Still another embodiment of the present invention is a computer system for analyzing clauses of business documents of an enterprise. Such a computer system may include at least one processor; at least one data storage device coupled to the at least one processor; a plurality of processes spawned by said at least one processor, the processes including processing logic for: providing a database; storing a plurality of business documents used by the enterprise in the database, each of the plurality of business document stored in the database including a plurality of clauses, each of the plurality of clauses being associated with a plurality of clause attributes and a clause attribute value for each of the plurality of clause attributes; prompting for a value of at least one of the clause attributes; obtaining at least one value for the prompted clause attributes; querying the database to identify all occurrences of clauses used in at least one of the stored business documents whose clause attribute values match each obtained value for the prompted clause attributes, and generating a business document clause analysis report that includes each identified matching clause occurrence.

### BRIEF DESCRIPTION OF THE DRAWINGS

FIG. 1 shows a method of authoring customized business documents based upon selected business document templates.

FIG. 2 shows an exemplary flow that may be used to initiate a business document clause analysis report, enter (and/or select) clause and business document information, run the search and generate the business document clause analysis report, according to an embodiment of the present invention.

FIG. 3 shows a Contract Clause Analysis page, Clause Attribute View, according to an embodiment of the present invention.

FIG. 4 shows a Contract Clause Analysis page, Specific Clauses View, according to an embodiment of the present invention.

FIG. 5 shows a Search & Select, Clauses page, according to an embodiment of the present invention. This page is accessed from the Specific Clauses View in FIG. 4 in order to allow the user to search and select specific clauses.

FIG. 6 shows an exemplary business document clause analysis report, according to an embodiment of the present invention.

FIG. 7 shows another embodiment of the present invention, in which the master table and details table of the generated business document clause analysis report are located on a same page.

FIG. 8 shows a computer system suitable for implementing embodiments of the present invention.

### DETAILED DESCRIPTION

Embodiments of the present invention may be deployed independently of or concurrently with the computer-implemented methods and systems disclosed in commonly assigned and co-pending U.S. patent application Ser. No. 11/020,605, filed Dec. 21, 2004, which application is hereby incorporated herein by reference in its entirety.

Embodiments of the present invention allow a business document administrator to find all the business documents where a given clause or set of clauses appears. After selecting the desired clauses and (optionally) the type of business documents to be searched, a business document clause analysis report may be generated containing all instances of the selected clauses in the business documents that were searched, thereby providing reporting capabilities to analyze clause usage on all corporate business documents within an enterprise (such as a corporation). For example, after selecting a standard clause as the desired clause to analyze its usage, embodiments of the present invention enable the user to find all instances of business documents where the selected standard clause is used (as-is or used with modifications i.e., made non-standard).

Within the context of the present document, the phrase ‘business document’ is understood to encompass any document (e.g., a legal document) whose content is subject to standards or policies of an enterprise, such as a corporation. Examples of such business documents may include contracts, licenses, pleadings, purchase orders, sales orders, settlements, quotes, request for quotes (RFQ) and the like. Also within the context of this document, a contract may be defined as a written agreement or promise between two or more persons (any legal entities that may enter and be bound by a contract) which creates an obligation to do or not to do a particular thing. A clause may be defined as a single paragraph or subdivision of a business document (such as a contract, for example). A clause of a business document may include as little as a single sentence or part of a sentence.

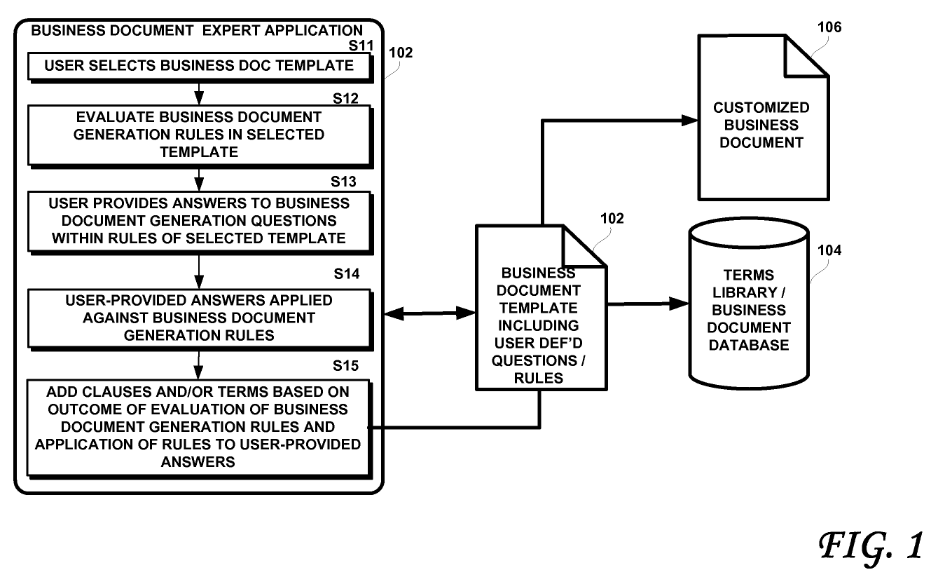

Turning now to the drawings, FIG. 1 shows a method of authoring customized business documents based upon selected business document templates. Reference numeral 102 is a simplified flowchart of a computer implemented method of authoring business documents. Such a method is further described in the aforementioned co-pending patent application Ser. No. 11/020,605, filed Dec. 21, 2004. It is to be noted that embodiments of the present invention may be practiced in conjunction with the methods described therein or may be practiced independently thereof

As shown in FIG. 1, reference S11 calls for the user to select a business document template 102 from among a plurality of available business document templates. The selected business document template 102 may include a nearly fully-formed business document (requiring only values to be input for the customer name, price and quantity variables, for example). Alternatively, the selected template 102 may dictate, recommend or make available selected business document terms or clauses, depending upon the requirements of the business document, and the values and answers entered by the business documents administrator or sales representative when negotiating the specific business document terms and clauses of the business document (e.g., a contract). Indeed, the selected business document template 102 may include a plurality of business document generation rules that must be evaluated against answers to questions and/or required entries. Indeed, as shown at S12, the selected business document template 102 may evaluate a plurality of business document generation rules included in or pointed to by the business document template, for the purpose of selecting and/or completing the constituent clauses or terms of the business document. As shown at S13, the sales representative or business document administrator may then provide answers to the questions within the rules of the selected template 102 (e.g., “NET-30” in response to a question “What are the payment terms?”) and/or provide any requested information. For example, the rules within the business document template 102 may request the customer name and dictate specific terms and/or clauses for business documents involving predetermined customers. For example, some customers may be entitled to or may have previously negotiated better credit terms or some other customers may be considered to be a relatively higher risk than others. The rules within the selected template 102 may then dictate inclusion of specific customer-specific clauses or terms or may, for example, report a policy deviation of the NET-30 term for a user-entered NET-45 payment term, as disclosed in commonly assigned and co-pending U.S. patent application Ser. No. entitled “Computer-implemented methods and systems for identifying and reporting deviations from standards and policies for contracts, agreements and other business documents,” which is incorporated herein in its entirety. Another example would be rules within the selected template that force the inclusion of predetermined clauses. For example, if a contract sells any items that are classified as ‘hazardous’ then certain special clauses need to be included. For example, such special clauses may limit liability of the seller and/or specify special Freight on Board (FOB) terms.

In step S14, the user-provided answers and other information requested by the selected template 102 may be evaluated against the business document generation rules of the template. Step S15 calls for terms and clauses to be added based upon the provided answers and information. The terms and clauses to be added to or incorporated into the resulting business document may then be retrieved from a terms library/business document database 104 and the customized business document assembled and generated, as shown at 106. The questions and business document generation rules within the selected template (and the selected template itself) may be drawn from the terms library/business document database 104 or from a different store altogether. A record of the clauses, business document terms and values of variables of the customized business document 106 may be stored in the terms library/business document database 104 and utilized to evaluate clauses (both standard and non-standard) used across all or certain types of business documents in the enterprise, as described fully hereunder. It is to be understood that the terms library/business document database 104, although shown in FIG. 1 and referred to herein as a single database, need not be configured as a single, unitary database. Indeed, the terms library/business document database may be configured as a single database or may include or span any number of databases.

Embodiments of the present invention are configured to find all instances of business documents where a selected clause or set of clauses are used. Embodiments of the present invention may also be used, for example, to find which of a company's contracts (or other business documents) make use of a certain legal concept or keyword or to research the effectiveness of particular clauses used by the company, and find whether some business document terms or clauses should be amended to correct any problematic language. Embodiments of the present invention may also be used, for example, to find which of a company's contracts (or other business documents) makes use of non-standard clauses that are not part of the company's standard library of clauses that contain approved standard legal language, and find whether some business document terms may present a risk for the company. Embodiments of the present invention generate a business document clause analysis report, which may be run upon user request. According to embodiments of the present invention, to run and generate the business document clause analysis report, the user or process may provide values for attributes and/or other information on which the search for clauses having matching attribute values may be performed. In response thereto, embodiments of the present invention may provide, among other possible information, a business document clause analysis report that lists or refers to all or selected occurrences of any clauses of business documents having attribute values that match the user-entered and/or selected attribute values, such as clause attribute values and/or business document attribute values.

Embodiments of the present invention may carry out a search on standard clauses that may be stored in a standard clause library or on non-standard clauses found in customized, individual business documents. It is envisaged that such non-standard clauses are, along with the standard clauses, in a clause library database that may be accessed and searched to provide the functionality described and shown herein.

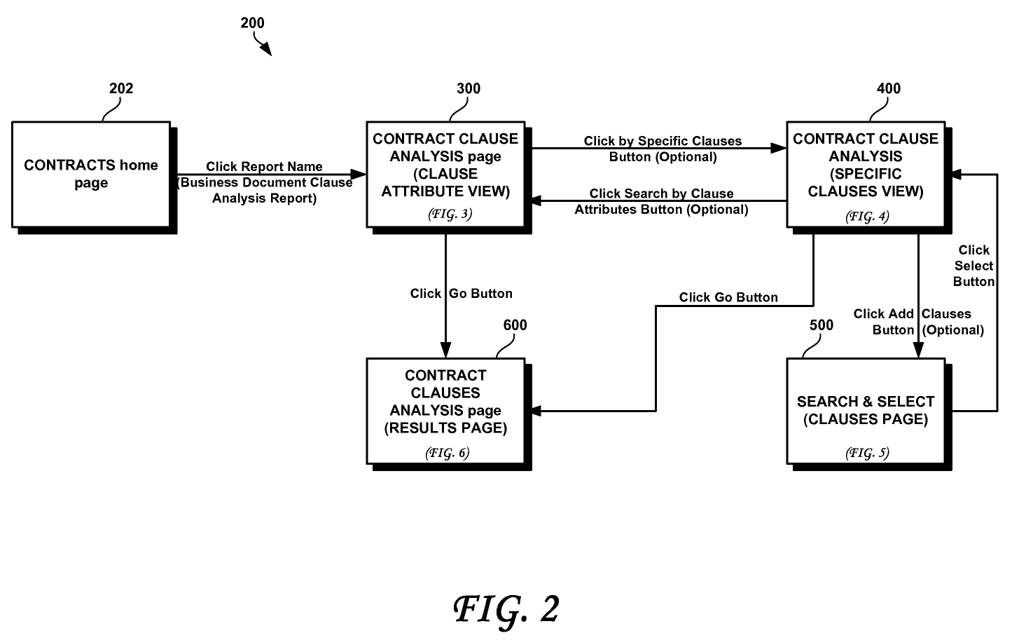

FIG. 2 shows an exemplary flow 200 that may be used to initiate a business document clause analysis report, enter clause and business document information (such as the aforementioned attribute values, for example), run the search and generate the business document clause analysis report, according to embodiments of the present invention. As shown therein, a computer application embodying aspects of embodiments of the present invention may include a contracts home page 202 from which the user may click or otherwise select a report name to run. The contracts home page 202 may include a list of contracts related actions from which the user may select the business document clause analysis report, to begin the process of generating a business document clause analysis report according to embodiments of the present invention.

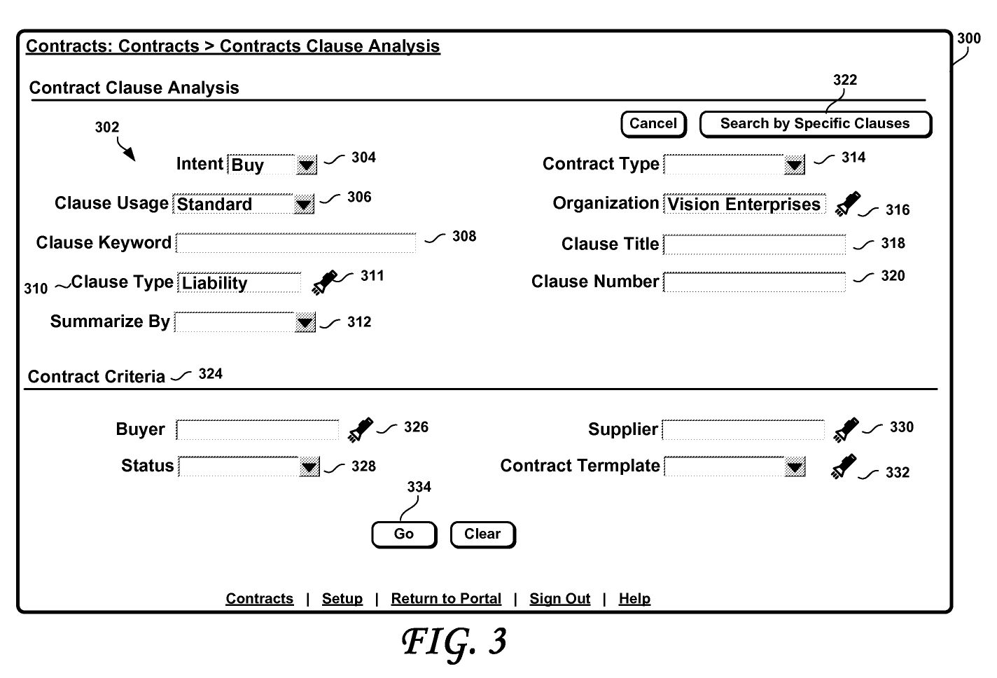

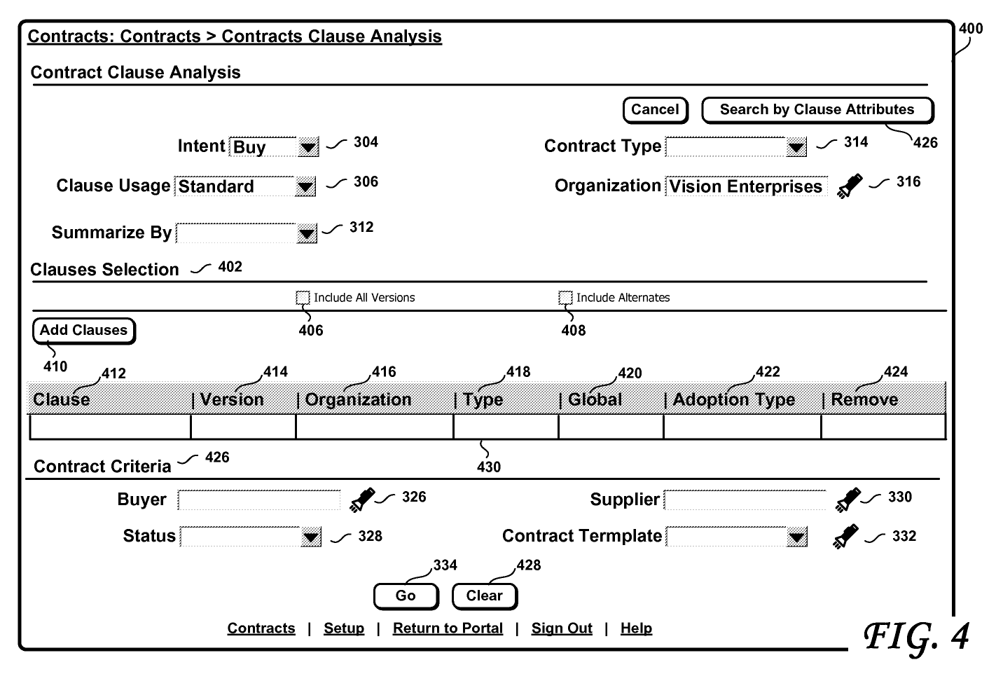

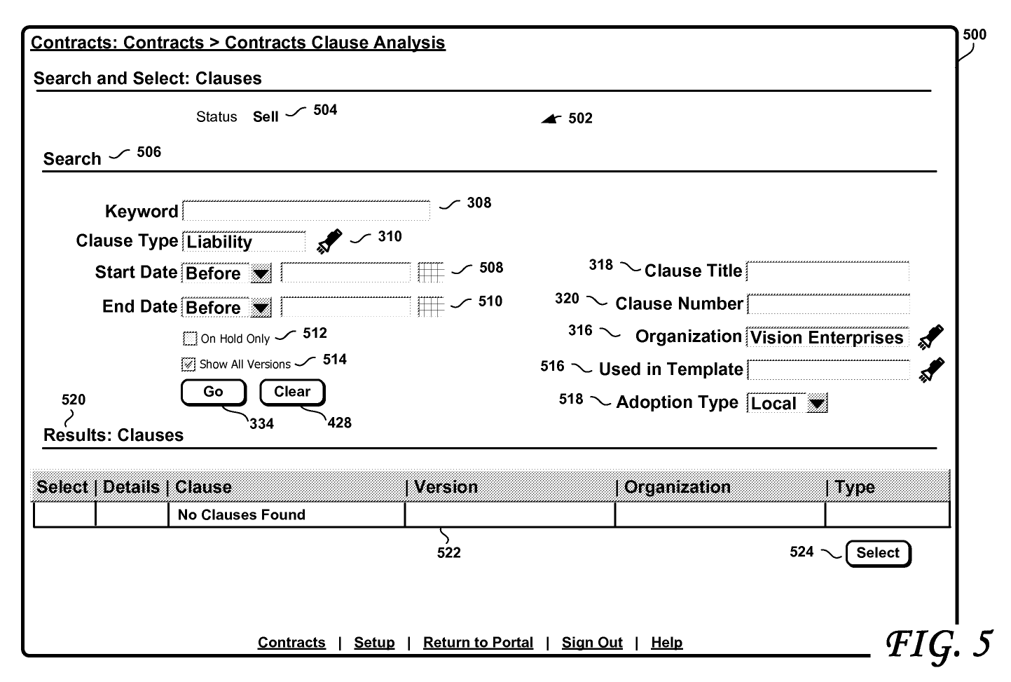

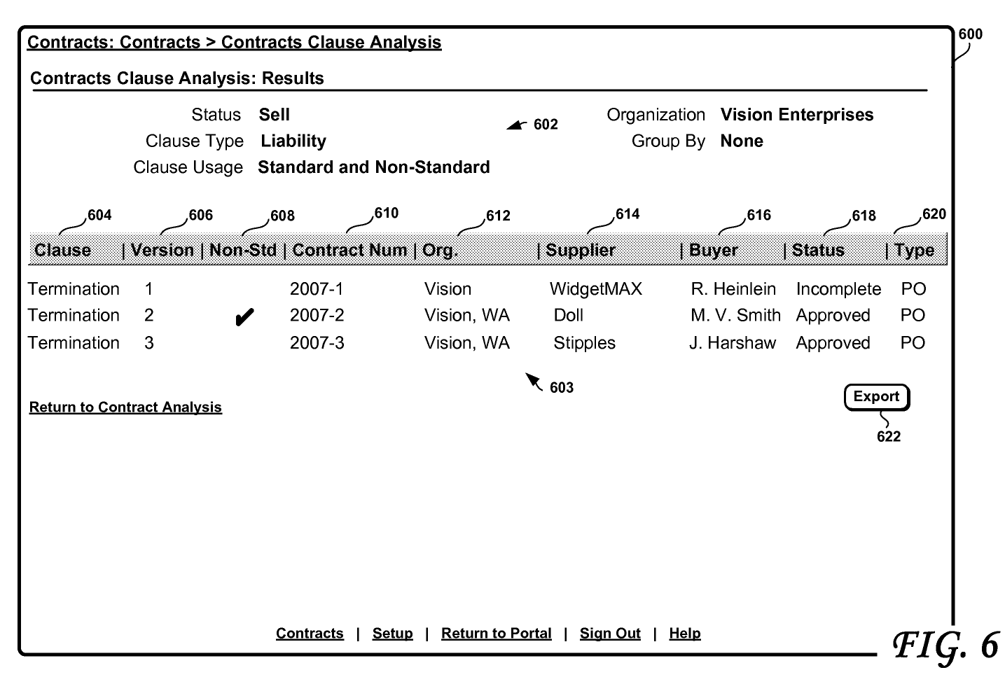

According to embodiments of the present invention, a user may select the clauses that are to be included in the business document clause analysis report to be generated—by specifying a particular named clause and/or by entering/selecting search conditions for a broader search. The clauses may be stored in a terms library/business document database 104 that may be accessed and queried to identify all clauses that match user-defined search conditions or criteria, as defined by user-entered and/or selected values for clause attributes and/or business document attributes. The terms library/business document database 104 may store the business documents of the enterprise (e.g., company or other organization) and the constituent clauses or references to standard clauses thereof. Indeed, search conditions may be set for the clauses of interest by entering and/or selecting the clause(s) by name and/or by entering and/or selecting values for clause attributes, and (optionally) filter criteria for the business documents to be searched for usage of these clauses, querying the terms library/business document database 104 to find all clauses of the stored business documents that satisfy the business document filter criteria and/or that include clause and business document attribute values that match the entered and/or selected values for the clause or business document attributes and generating a business document clause analysis report that includes all of the identified clauses. The business document clause analysis report may advantageously include a summarization feature that enables the results to be summarized, for example, by clause type, version and/or clause name. This may be carried out in the Contract Clause Analysis page, Clause Attribute View 300 and/or by selecting certain clause attributes, and setting search/filter conditions for the business documents. The business document clause analysis report may also include an identification of the business document in which the clauses listed in the report appear. The business document clause analysis report may also be run from the Contract Clause Analysis page, Specific Clause View 400 (to analyze usage of specific ‘named’ clauses, as opposed to the broader search described above). The Contract Clause Analysis page, Clause Attribute View 300 (further shown in and described relative to FIG. 3) may include functionality to enable a user to view clause attributes, and to set clause and contract search conditions by entering and/or selecting values for such clause and/or business document attributes. From the Contract Clauses Analysis page, Clause Attribute View 300, the user may choose to search by specific clauses via the Contract Clause Analysis, Specific Clauses View page 400, in which the user may view clauses that have been selected individually (to be analyzed), launch clause selection, and set contract search conditions, for example. The Contract Clause Analysis, Specific Clause View page 400 is further shown in and described relative to FIG. 4. From the Contract Clause Analysis, Specific Clauses View page 400 (FIG. 4), the user may click or otherwise select to search by clause attributes to return to the Contract Clause Analysis, Clause Attribute View page 300 (FIG. 3). The Search and Select, Clauses page 500, further shown in and described relative to FIG. 5, enables a user to search and to select individual clauses for inclusion in the analysis of the business document clause usage. In the Search and Select, Clauses page 500, clause selection may be carried out by setting search conditions (by, e.g., providing or selecting values for clause attributes) on the clauses, filtering the results, and adding and removing individual clauses. Users can also decide to include specific versions of selected clauses for the clause analysis or analyze all versions of the selected clauses. This Search and Select, Clauses page 500 may be accessed from the Contract Clause Analysis, Specific Clauses View page 400 by clicking an Add Clauses button, for example, to search on a user-specified or named clause. According to embodiments of the present invention, from either the Contract Clause Analysis, Clause Attribute View page 300 or the Contract Clause Analysis, Specific Clause View page 400, the user may generate the business document clause analysis report, which may be rendered on a Contract Clauses Analysis, Results page 600, which page and functionality is further shown and described relative to FIGS. 6-9.

Although the figures include the terms “contract” and “contracts”, such terms are expressly defined herein to also encompass any other type of structured business documents such as, for example, quotes, agreements, memoranda, licenses, purchase orders, sales orders, request for proposals (RFQ), assignments and settlements, among many other possibilities.

At 300, FIG. 3 shows a Contract Clause Analysis page, Clause Attribute View, according to an embodiment of the present invention. This page 300 affords the user the ability to select the conditions on which the clauses and the business documents are to be searched and to generate a business document clause analysis report according to the results of the search. As shown, the Contract Clause Analysis page, Clause Attribute View 300 may include two regions; namely a main search region 302 to enable the user to enter and/or select attributes values for clauses and a contract criteria region 324 for additional contracts attributes. Embodiments of the present invention may be configured to require at least one condition (by entering and/or selecting at least one value for a clause attribute) to be entered (i.e., no blind queries may be allowed) by the user for a business document clause analysis report to be generated. The main search region 302 may be configured to include an Intent pull down menu 304. The Intent pull down menu 304 may allow the user to select either “Buy” or “Sell” contracts on which to search. A Clause Usage pull down menu 306 may also be provided, which allows the user to select whether they want to search contracts where the clauses have been used as standard clauses, made non-standard or search for both standard and non-standard usage. For example, this enables the user to search for and find all business documents that include a selected clause that has been used without modifications (standard usage), or with modifications (non-standard usage). The default value of the Clause Usage pull down menu 306 may be standard and non-standard clauses, which casts the widest net and shows all contracts where the clause has been used with or without modifications (standard and non-standard usage).

Clauses may also be searched by keyword and the user may enter any desired keyword or phrase in the keyword text field 308. Embodiments of the present invention may be configured to search for the entered keyword in any one or several fields such as, for example, clause text, description, title and display name. Should the clause include metadata or other tagging information, the keyword search may be configured to search on a clause's metadata or other tagging information. Indeed, the clause attribute values and the business document attribute values may be considered to be metadata to the business documents and/or to the clauses thereof. In that case, the querying of the terms library/business document database 104 may be carried out on such metadata to identify all matching clauses and then identify all business documents that use those matching clauses. Clauses may also be searched by Clause Type, as shown at 310. Clause Type can be selected from a List of Values (LOV), which can be displayed by selecting the LOV icon 311. The LOV icon 311 may bring up, when selected, a list of possible clause types (e.g., Payment Terms, Liability, Indemnity, Choice of Law, Force Majeure, and the like). The resulting business document clause analysis report may be summarized by, e.g., Clause, Clause Version, Clause Type or None, and such may be selected at 312. The Contract Type 314 attribute may be selected at 314, as may be the Organization (e.g., company name; in this exemplary and illustrative case, Vision Enterprises). The organization LOV allows the user to further narrow the search criteria to cause the generated business document clause analysis report to include only business documents relating to the selected organization. The organization LOV may be populated as business documents for new organizations and the constituent clauses thereof are entered into the terms library/business document database 104, from which the search may be carried out.

The contract criteria region 324 may be configured to enable the user to enter and/or select business document attribute values such as, for example, a Buyer (when “Buy” is selected from the Intent pull down menu 304 or Seller when “Sell” is selected from the Intent pull down menu 304), the Status 328 of a business document (e.g., Draft, Active, etc.), a selected Supplier (or ‘Customer’ if the intent is ‘Sell’) (which may be selected from a LOV) and a Contract (or other business document) Template (such as 102 in FIG. 1, for example). The Contract Template attribute values may be organized as a LOV, as shown at 332. Clicking on the Go button 334 causes the search to be carried out on the business documents in the terms library/business document database 104 (e.g., a database of business documents and clauses for such business documents) and the business document clause analysis report to be generated and rendered for the user, examples of which is shown in FIGS. 6, 7, 8 and 9.

Rather than entering/selecting values in the Contract Clause Analysis page, Clause Attribute View 300, the user may click on or otherwise select the Search by Specific Clauses button 322 which may bring the user to a page such as shown at FIG. 3. According to embodiments of the present invention, if the user enters and/or selects (from a LOV, for example) one or more values for the clause or business document attributes 304-332 and clicks Search by Specific Clauses button 322, the entered values/search criteria will not be retained and the search will proceed according to the clauses specified by the user.

At 400, FIG. 4 shows a Contract Clause Analysis page, Specific Clause View, according to an embodiment of the present invention. To search for “named” clauses; that is, to select specific clauses for inclusion into the business document clause analysis report, the user may enter and/or select attributes values for the clauses, as shown at 304, 306, 312, 314 and 316, in a manner similar as that shown in and described relative to FIG. 3.

Specific clauses may be added, by clicking or otherwise selecting the Add Clauses button 410 one or more times. Clicking or otherwise selecting the Add Clauses button 410 takes the user to the Search and Select, Clause page 500 (see FIGS. 2 and 5), where individual named clauses may be searched and selected. This may be useful for searching for and retrieving a list of specifically identified clauses that are used in one or more business documents. For example, a specific clause may need to be updated and the user may wish to generate a list of all instances of such specific clauses and an indication of the business documents that include such specific clauses. Thereafter, the user may choose to amend all or selected ones of the business documents that include the specific clause.

Returning now to FIG. 5, the data associated with the selected individual clauses may be used to populate the fields 412-424 (with each selected clause appearing as a row in the table). After having selected the desired clauses, the Go button 334 may be clicked to run and generate the business document clause analysis report. If the user enters some clause and/or business document attribute values into one or more of the fields of FIG. 4 and subsequently clicks the Search By Clause Attributes button 426, the entered values and/or search criteria may not be retained and the user may be returned to the Contract Clause Analysis page, Attribute View 300 of FIG. 3.

Each time the user clicks the Add Clauses button 410 and selects clauses on the Search and Select, Clauses page 500 (FIGS. 2 and 5), any newly selected clauses may be appended to any of the clauses already present in the table. The Clear button 428 clears all entered and/or selected attribute values and also empties the clause table (i.e., the information entered into the fields 412-424).

As shown in FIG. 4, the Contract Clause Analysis, Specific Clause view 400 may (but need not) include three regions; namely, a main search region, which enables the user to enter search criteria by entering and/or selecting attribute values for both clauses and contracts (304, 306, 312, 314 and 316); a clause selection region 402, which may be configured to list all the clauses that have been selected for the report, and launches clause selection; and a contract criteria region 426, enabling the user to select business document-level (e.g., contract-level) search criteria, such as the aforementioned Buyer LOV 326, the Status pull down menu 328, the Supplier LOV 330 and the Contract Template LOV 332. Therefore, the main search region may be used to enter and/or select search criteria for the clause usage and the clause selection region may be used to select particular named clauses for inclusion in the report. Therefore, the generated report may include the business documents that include the added clauses and that satisfy the search criteria entered and/or selected in the main search region. As is the case in the Contract Clause Analysis page, Clause Attribute View 300 of FIG. 3, embodiments of the present invention may be configured to disallow blind queries in this page, so as to effectively limit the number of clauses and contracts retrieved as a result of the search to a number that is smaller than the total number of contracts and clauses present in the terms library/business document database 104 on which the search is to be performed.

The clause selection region may also include an Include All Versions checkbox 406 which, if left unchecked by the user, includes only the selected versions of selected clauses. An Include Alternates checkbox 408 may also be provided. If checked, the Include Alternates checkbox 408 causes the generated business document clause analysis report to include all alternate clauses of each selected clause to be included in the analysis. According to embodiments of the present invention, if the user checks both the Include Adopted Clauses and the Include Alternates checkboxes 404, 408, the alternates of the selected clauses will be added, followed by all versions of all the previously added clauses, followed by all adoptions of all the previously added clauses.

When the user clicks or otherwise selects the Add Clauses button 410 in FIG. 4, the user may be presented with the Search and Select, Clauses page 108 of FIG. 5. As shown in FIG. 5, the user may enter one or more search attribute values on which the search of the terms library/business document database 104 is to be performed, for the purposes of adding clauses to the Clauses Selection region 402 of FIG. 4 and to populate the fields 412-424 of the table of FIG. 4.

To select clauses on this page, the user may enter and/or select values for attributes (308, 310, 508, 510, 512, 514, 318, 320, 316, 516, and 518) and click the Go button 334, whereupon the selected clauses whose attribute values match the user-entered and/or user-selected clause and/or business document attribute values will appear in the table 522. The search may be carried out according to such search criteria (the user-entered and/or user-selected clause and/or business document attribute values) and may include, according to embodiments of the present invention, all clauses whose stored attribute values match each of the attribute values entered and/or selected. Therefore, the search criteria may be considered to be, in the aggregate, a Boolean AND of each of the entered and/or selected attribute values and those clauses that correspond to each of the entered and/or selected clause attribute values will be selected for inclusion in the business document clause analysis report to be generated.

Clauses that match the search criteria are shown in table 522 and selected for inclusion, but may be de-selected (or selected for exclusion from the table 522), so that only the desired clauses are transferred to table 430 in FIG. 4. Clicking the Select button 524 brings the user back to the Contract Clause Analysis, Specific Clauses View page 106 of FIG. 4, with the selected clauses added to the Clause Selection table 430 on that page.

According to embodiments of the present invention, the Search and Select, Clauses page 500 of FIG. 5 may include a View-Only attribute region 502, for displaying attribute values already selected before coming to this page. In this exemplary case, the Intent “Sell” attribute value was pre-selected for the Intent attribute, for example, at 304 in FIG. 4. The view-only attribute region 502 may be configured to display the Intent (e.g., “Buy” or “Sell”) from a previously displayed LOV, and/or the Organization, also from a previously displayed LOV. As may be appreciated, the value of the Organization attribute (e.g., Vision Enterprises in the example being developed herein or the name of some other organization) is shown in the View-Only attribute region 502 if previously selected (e.g., at 316 in FIG. 4).

A Search region 506 may also be provided affording the user the opportunity to enter attributes values to search for individual clauses. The Keyword text field 308, Clause type LOV 310, Clause Title text field 318, Clause Number text field 320 and the Organization LOV 316 in the Search region 506 have been previously discussed, relative to FIG. 3, and a detailed description thereof is not repeated here. The Search region 506 may, according to embodiments of the present invention, be configured to also include a Start Date attribute 508 and an End Data attribute 510, to enable the user to specify the start and end dates of clauses to be returned in Results table 522. Start and end dates may be specified to be “Before”, “After” or “Is” (selected using a pull-down LOV) the specified date. The Search region 506 may also include an On Hold Only checkbox 512. By default, this checkbox may be configured to be unchecked. When checked, this checkbox causes the clause search to include only clauses that are on hold. A Show All Versions checkbox 514 may also be provided. When checked, all versions of the clauses that satisfy the entered search attributes will be included in the business document clause analysis report to be generated. If unchecked, the Show All Versions checkbox 514 will cause only the latest approved version of each selected clause to be included in the business document clause analysis report to be generated. The Search region 506 may also include a Used in Template text field that the user may populate using a LOV. The Used in Template LOV 516 enables the user to select from among a plurality of templates in which the desired clauses were included. The Adoption Type pull down menu 518 may also be populated using a LOV. The available values, for example, may depend upon the nature of the organization selected at 316. For example, if a global organization was chosen at 316, the available values for this field may be Global, Local or blank. If a local organization was chosen at 316, the available values for this field may be selected from Local, Adopted, Localized or blank. Lastly, if no organization was chosen at 316, the available values for this field may include all of the above adoption types; namely, Global, Local, Adopted, Localized or blank. Finally, the Search and Select, Clauses page 500 may include a Results region 520, which may be configured to list the clause search results (in tabular form, for example) from which the user may select the ‘named’ clauses to be included in the final report by selecting the ‘Select’ button 524.

FIG. 6 shows an exemplary business document clause analysis report, according to an embodiment of the present invention. As shown therein, the business document clause analysis report 600 may include a first region 602, which may detail the attribute values previously entered by the user such as, for example, Intent, Clause Type, Clause Usage, Organization. The second region 604 of the business document clause analysis report may list all instances of the clauses as used in business documents, that match each of the user-entered or user-selected attributes values (for clauses and business documents). For example, the clauses may be listed in a tabular format with each row referring to a particular usage of the clause in a particular business document. As the Group By field indicates that the user did not enter a value for the ‘Summarize By’ field, the clauses that match the user-entered and/or selected attribute values are not grouped in any particular order, but are listed as a flat list of all occurrences.

As shown in FIG. 6, the clauses retrieved as a result of the search are those whose clause attribute values and/or business document attribute values (which may be stored along with the business documents in the terms library/business document database 104) that match the user-entered and/or user-selected attribute values; namely, those clauses of Vision Enterprise's Sell-side contracts in which they were used with or without modifications (standard or non-standard usage or both). All instances of the clauses as used in business documents, whose stored clause attribute values and/or business document attribute values that match the user-entered and/or selected attribute values are shown in table 603. These clauses are those clauses of the business documents stored in the terms library/business document database 104 whose clause attribute values and/or business document attribute values are found to match the user-entered and/or user-selected clause attribute values and/or business document values after the terms library/business document database 104 is queried and all matching stored clauses identified. In FIG. 6, there are three exemplary clauses listed at 604. As shown, the clauses may be listed by clause name 604, clause version 606, whether the clause was used with or without modifications (standard or non-standard) as shown at 608, the contract number 610 (or other unique business document/contract identifier) in which the clause is used, the organization 612, the supplier (or Customer) with whom the contract was negotiated, the name of the internal buyer as shown at 616, the status of the contract/business document in which the clause appears and the type of the contract/business document in which the clause appears (in this case, a Purchase order PO), as shown at 620. As shown in this illustrative business document clause analysis report, the termination clause (version 2) was used in contract 2007-2 and was modified. As this clause was modified, a check mark appears in the non-standard column 608. Any change to a standard clause may cause that clause to be flagged in the terms library/business document database 104 as a non-standard clause. Embodiments of the present invention may include an Export button 622, to enable the user to export the generated business document clause analysis report to, for example, Portable Document Format (PDF), a word processing format such as Microsoft Word or a spreadsheet, such as Microsoft Excel, for example. It is to be noted that the above example was illustrative and the same analysis can be done on ‘sell’ contracts and the search criteria for business document/contract changes accordingly (namely Customer instead of Supplier, Sales Representative instead of Buyer etc.>

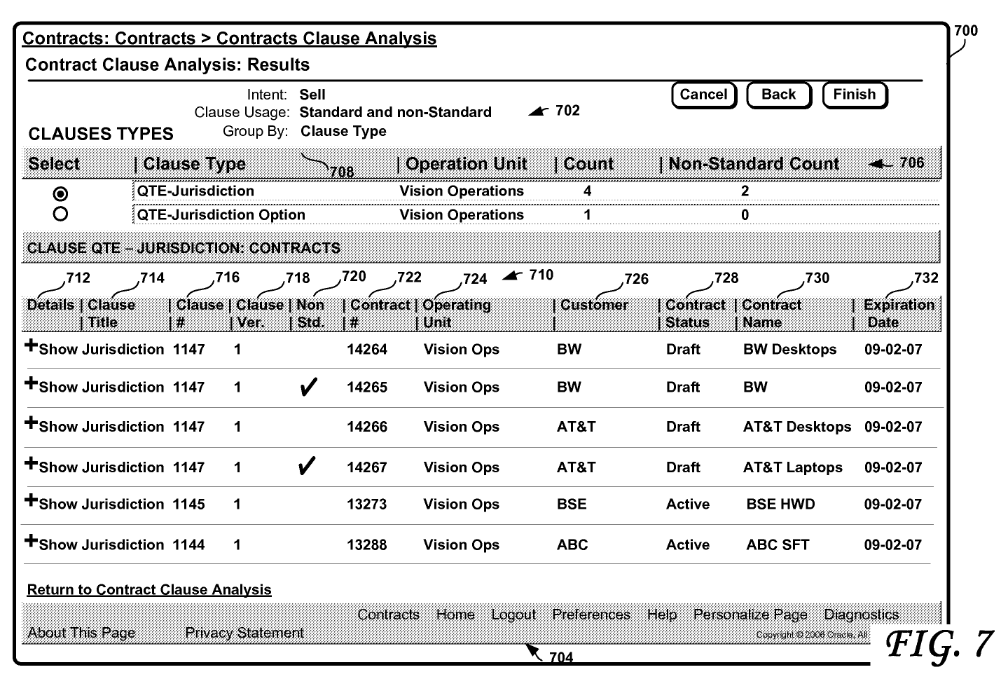

FIG. 7 shows another embodiment of the present invention, which presents the results of the search in a Master-Detail format that includes a master table and a details table. The master table summarizes information in the child table based on the value of the ‘Summarize By’ attribute 312 in FIG. 4. In this example, the generated business document clause analysis report may include a first region 702 and a second region 704. The first region 702 may include the clause and/or business document attribute values previously entered and/or selected by the user—in this case, the values entered by the user for the Intent, Clause Usage and clause type attributes. The information in the second region 704, labeled “Clauses” may be summarized in the master table 706. The master table summarizes the clauses retrieved as a result of the search according to the values of the Summarize By attribute entered by the user. In this case, the master table 706 lists the retrieved clauses summarized by clause type, as shown at 708. The two clause types for which clauses exists that match the attribute values entered and/or selected by the user are, in this exemplary case, QTE-Jurisdiction and QTE-Jurisdiction Option. Indeed, the clauses returned happen fall under two clause types—QTE Jurisdiction and QTE Jurisdiction Option. These clauses were used in a total of seven contracts (the first clause was used in six contracts, and the second clause was used in one contract). The first Jurisdiction clause type (QTE-Jurisdiction) includes two occurrences of clause 1147 that were made non-standard in two contracts (contracts 142565 and 14267).

In this example, the user has selected to look at the six contracts that include clauses of the QTE-Jurisdiction type. These six contracts are listed in the details table 710 in the second region 704. In this implementation of the generated business document clause analysis report, the details table 710 has been configured to include functionality to show additional details of the retrieved clause, as shown at 712. The clause title may also be provided, as shown at 714. The details table 710 may also include, for example, the clause number 716, the clause version 718, the contract number 722 where the retrieved clause was found, the operating or other business unit 724 where the contract was authored/executed, the customer 726, the contract status 728, the contract name 730 and the expiration date 732. Other information may be shown in the master and detail tables, embodiments of the present invention are not being limited to the exemplary tables and reports shown herein for illustrative purposes only.

According to embodiments of the present invention, the clauses of business documents are stored in a terms library/business document database, such as shown at 104 in FIG. 1. It is this terms library/business document database 104 (whether the terms library/business document database 104 is a single database or spans multiple database) that may be searched to retrieve specific clauses that have (or are associated with) attribute values that match the attribute values entered and/or selected by the user. For each clause, a relationship may exist between the contract clauses used in contracts or other business documents and standard library clauses. Whenever a clause is modified in a particular business document (such as a contract, for example), a “non-standard” attribute value may be associated with that clause and the modified clause stored separately with just a reference to the standard clause. In addition, new non-standard clauses may be authored from scratch and stored in the terms library/business document database 104. These newly authored clauses may be assigned a clause type and other attributes for reporting purposes and to enable embodiments of the present invention to retrieve them should they match user entered and/or selected attribute values.

Advantageously, embodiments of the present invention enable users (which may include global business practice users, contract administrators, or legal departments, for example) to understand how clauses are used in contracts or other business documents by running business document clause analysis reports based on user-entered and/or selected values of a number attributes. Such a business document clause analysis report provides the user with all standard or non-standard usage of clauses that match the entered and/or selected attribute values, and has the functionality to summarize the occurrences of such clauses based upon user specified attribute values (e.g., summarize by none, clause, clause type, clause version, etc.)

For example, the exemplary company Proserve alluded to above may be concerned about risk due to non-standard indemnity clauses. Using an embodiment of the present invention, users can query the terms library/business document database 104 to view all contracts that have non-standard indemnity clauses. In another scenario, Proserve's standard termination clause requires written notice. The company has previously had issues with contracts where the contracts' termination clauses were modified to allow either verbal or written notice of termination. Using an embodiment of the present invention, users may query the terms library/business document database 104 to view all contracts having termination clauses that include the word “verbal”, as each retrieved clause may include an indication of the contract number in which the clause is located. In yet another scenario, Proserve realizes that contract administrators are generally finding the need to modify the standard Proserve nondisclosure clause in order to reach agreement in negotiating agreements. Using embodiments of the present invention, users can query the terms library/business document database 104 to view all contracts where the nondisclosure clause has been modified, in an attempt to determine the reasons why the standard clause might not be sufficient in most cases. Alternatively still, Proserve has been involved in a lawsuit where a standard limitation of liability clause did not stand up to close scrutiny. Proserve would then likely want to analyze all pending contracts using this standard limitation of liability clause. Using an embodiment of the present invention, users can query the terms library/business document database 104 to view all contracts using the defective limitation of liability clause. Proserve could then use this information to determine if it should consider renegotiating this clause in ongoing deals. These are just a few examples of how the functionality afforded by embodiments of the present invention may be beneficial to companies, by providing a ready tool to analyze clause usage on corporate contracts and all other business documents. Indeed, embodiments of the present invention allow companies to reduce risk and improve compliance by understanding how both standard and non-standard clauses are being used across its business documents.

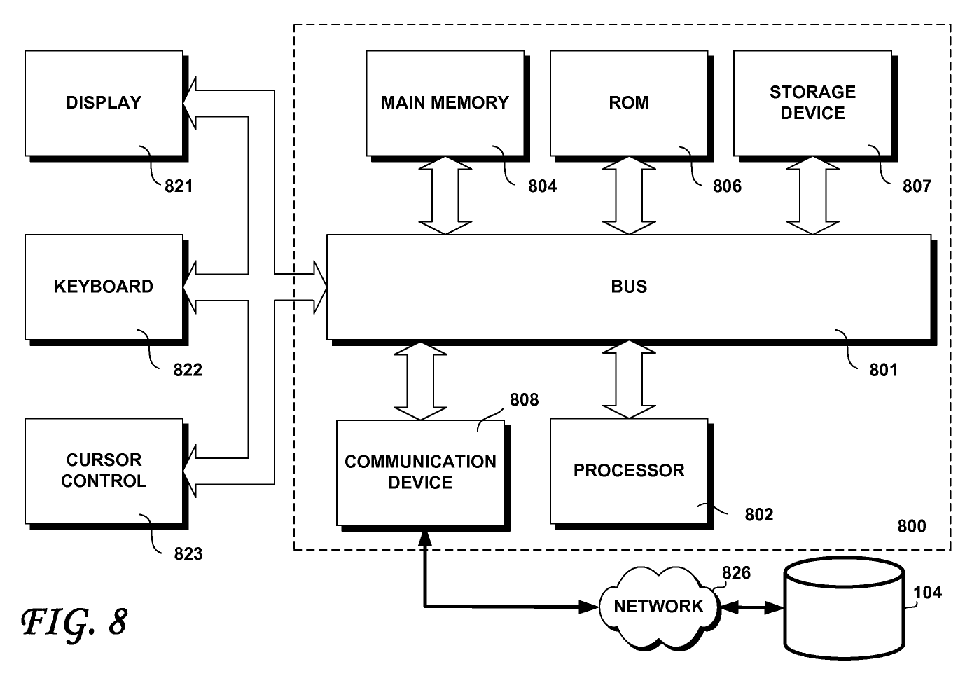

FIG. 8 illustrates a block diagram of a computer system 800 with which embodiments of the present inventions may be implemented. Computer system 800 includes a bus 801 or other communication mechanism for communicating information, and one or more processors 802 coupled with bus 801 for processing information. Computer system 800 further comprises a random access memory (RAM) or other dynamic storage device 804 (referred to as main memory), coupled to bus 801 for storing information and instructions to be executed by processor(s) 802. Main memory 804 also may be used for storing temporary variables or other intermediate information during execution of instructions by processor 802. Computer system 800 also includes a read only memory (ROM) and/or other static storage device 806 coupled to bus 801 for storing static information and instructions for processor 802. A data storage device 807, such as a magnetic disk or optical disk, is coupled to bus 801 for storing information and instructions. The computer system 800 may also be coupled via the bus 801 to a display device 821 for displaying information to a computer user. An alphanumeric input device 822, including alphanumeric and other keys, is typically coupled to bus 801 for communicating information and command selections to processor(s) 802. Another type of user input device is cursor control 823, such as a mouse, a trackball, or cursor direction keys for communicating direction information and command selections to processor 802 and for controlling cursor movement on display 821. A communication device (e.g., an Ethernet card) may also be coupled to the bus 801 to enable the computer system 800 to communicate with, for example, the clause library database 84 over a network 826 (which may include the Internet, for example) to achieve the functionalities shown and described herein.

Embodiments of the present invention are related to the use of computer system 600 and/or to a plurality of such computer systems to enable methods and systems for analyzing clauses of business documents and for generating business document clause analysis reports. According to one embodiment, the computer-implemented methods for generating report such business document clause analysis reports as shown and described herein may be provided by one or more computer systems 800 in response to processor(s) 802 executing sequences of instructions contained in memory 804. Such instructions may be read into memory 804 from another computer-readable medium, such as data storage device 807. Execution of the sequences of instructions contained in memory 804 causes processor(s) 802 to perform the steps and have the functionality described herein. In alternative embodiments, hard-wired circuitry may be used in place of or in combination with software instructions to implement the present invention. Within the context of this document, a ‘computer-readable medium’ may be or include any means that can contain, store, communicate, propagate or transport a program or application that implements an embodiment of the present invention for use by or in connection with a computerized system, apparatus, or device. Indeed, the computer readable medium may be or include (but is not limited to), for example, an electronic, magnetic, optical, electromagnetic, infrared, or semi-conductor system, apparatus, device, or propagation medium. More specific examples (a non-exhaustive list) of computer-readable media would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (such as a CD or DVD-ROM, for example).

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. Thus, the present invention should be limited only by the claims as set forth below.

What is claimed is:

1. A computer-implemented method for analyzing clauses of business documents of an enterprise, comprising the steps of:
providing a database;
storing a plurality of business documents used by the enterprise in the database, each of the plurality of business document stored in the database including a plurality of clauses, each of the plurality of clauses being associated with a plurality of clause attributes and a clause attribute value for each of the plurality of clause attributes;
prompting for a value of at least one of the clause attributes;
obtaining at least one value for the prompted clause attributes;
querying the database to identify all occurrences of clauses used in at least one of the stored business documents whose clause attribute values match each obtained value for the prompted clause attributes, and
generating a business document clause analysis report that includes each identified matching occurrence.

2. The computer-implemented method of claim 1, wherein each of the plurality of business documents is further associated with a plurality of business document attributes and a business document attribute value for each of the plurality of business document attributes and wherein the computer implemented method further includes steps of:
prompting for a value of at least one of the business document attributes;
obtaining at least one value for the prompted business document attributes;
querying the database to identify all occurrences of clauses used in at least one of the stored business documents whose business document attribute values match each obtained value for the prompted business document attribute, and wherein the report generating step is carried out such that the business document clause analysis report is configured to include each identified matching clause occurrences.

3. The computer-implemented method of claim 1, wherein the plurality of clause attributes includes a Summarize By clause attribute and wherein the method further includes a step of prompting and obtaining a value for the Summarize By clause attribute and wherein the generated business document clause analysis report is summarized according to the obtained value of the Summarize By clause attribute.

4. The computer-implemented method of claim 3, wherein the Summarize By clause attribute includes selectable values of Clause, Clause Version, Clause Type and None.

5. The computer-implemented method of claim 2, wherein one of the plurality of business document attributes is a unique business document identifier and wherein the report generating providing step is carried out with the business document clause analysis report providing, for each identified clause, the unique business document identifier where the identified clause is found.

6. The computer-implemented method of claim 1, further comprising a step of selecting additional clauses to add to the business document clause analysis report and wherein the report generating step is carried out with the business document clause analysis report including the selected additional clauses.

7. The computer-implemented method of claim 1, wherein the report generating step is carried out with the business document clause analysis report including all versions of at least one of the identified clauses.

8. The computer-implemented method of claim 2, wherein the querying to identify step is carried out such that each of the obtained values for the business document and clause attributes must match a corresponding one of the values for the associated business document attributes and the clause attributes.

9. The computer-implemented method of claim 1, wherein the report generating step is carried out with the business document clause analysis report including a master table that includes a summary of the identified clauses and a selectively configurable details table that lists selected clauses from the summary.

10. The computer-implemented method of claim 1, wherein some of the clauses of the stored business documents are non-standard clauses and wherein the report generating step is carried out with the business document clause analysis report identifying those of the identified clauses that are non-standard.

11. The computer-implemented method of claim 1, wherein the clause attributes include at least one of Intent, Clause Usage, Clause keyword, Clause Type, Summarize By, Clause title, Clause Number and Organization.

12. The computer-implemented method of claim 2, wherein the business document attributes include at least one of Buyer, Seller, Status, Supplier and Contract Template.

13. A machine-readable medium having data stored thereon representing sequences of instructions which, when executed by a computing device, causes the computing device to analyze clauses of business documents of an enterprise, by performing the steps of:
providing a database;
storing a plurality of business documents used by the enterprise in the database, each of the plurality of business document stored in the database including a plurality of clauses, each of the plurality of clauses being associated with a plurality of clause attributes and a clause attribute value for each of the plurality of clause attributes;
prompting for a value of at least one of the clause attributes;
obtaining at least one value for the prompted clause attributes;
querying the database to identify all occurrences of clauses used in at least one of the stored business documents whose clause attribute values match each obtained value for the prompted clause attributes, and
generating a business document clause analysis report that includes each identified matching clause occurrence.

14. A computer system for analyzing clauses of business documents of an enterprise, the computer system comprising:
at least one processor;
at least one data storage device coupled to the at least one processor;
a plurality of processes spawned by said at least one processor, the processes including processing logic for:
providing a database;
storing a plurality of business documents used by the enterprise in the database, each of the plurality of business document stored in the database including a plurality of clauses, each of the plurality of clauses being associated with a plurality of clause attributes and a clause attribute value for each of the plurality of clause attributes;
prompting for a value of at least one of the clause attributes;
obtaining at least one value for the prompted clause attributes;
querying the database to identify all occurrences of clauses used in at least one of the stored business documents whose clause attribute values match each obtained value for the prompted clause attributes, and
generating a business document clause analysis report that includes each identified matching clause occurrence.
